(19) United States
(12) Patent Application Publication
(10) Pub. No.: US 2009/0176494 A1
(43) Pub. Date: Jul. 9, 2009

(54) HANDOVER CONTROLLING PROCESS CAPABLE OF DETECTING LOST HANDOVER MESSAGE

(76) Inventors: Chi-Chen Lee, Taipei City (TW); Tsai-Pao Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/346,895

(22) Filed: Dec. 31, 2008

Related U.S. Application Data
(60) Provisional application No. 61/018,894, filed on Jan. 4, 2008.
(60) Provisional application No. 61/030,584, filed on Feb. 22, 2008.

(51) Int. Cl. H04W 36/00

(52) U.S. Cl. 455/436

(57) ABSTRACT

The behavior of an MS and Serving BS is clarified in a situation where a handover message, such as a handover request message or an indication message, is lost. By setting a timer and an acknowledgement of the handover message, a handover control process is capable of detecting the loss of the handover message. When the loss is detected, the MS or the Serving BS can resend the lost message or perform some repairing steps to avoid asynchronous states of the MS and the Serving BS.

### CROSS REFERENCE TO RELATED APPLICATIONS

This application claims the benefit of U.S. Provisional Application No. 61/018,894, filed on Jan. 4, 2008 and included herein by reference.

This application claims the benefit of U.S. Provisional Application No. 61/030,584, filed on Feb. 22, 2008 and included herein by reference.

### BACKGROUND OF THE INVENTION

1. Field of the Invention

The present invention relates to a handover handshake process, and more particularly, to a handover handshake process that is capable of detecting whether a handover message is lost.

2. Description of the Prior Art

The present invention relates to a handover handshake process, and more particularly, to a handover handshake process that is capable of detecting whether a handover message is lost.

Each base station for a communication system is assigned a limited coverage area. When a mobile station (MS) leaves the particular coverage area of the serving base station (SBS) while a call is in progress, the MS will change its connection from the Serving BS to another base station (BS). The call in progress will not terminate because the connection between the MS and the Serving BS will not be released until the MS has fully established a new connection to another BS. This process is called handover. During the handover process, the call in progress can always be transferred to a BS or a channel that is more suitable for the MS; thereby a better communication quality can be obtained.

To start a handover process, a handover request must be sent first. Referring to FIG. 1, which is a diagram showing a conventional handover handshake process between a MS 10 and a Serving BS 12, the MS 10 first sends a request message MOB_MSHO-REQ 102 to the Serving BS 12, and a response message MOB_BSHO-RSP 104 is sent by the Serving BS 12 to the MS 10 to notify the MS 10 that the Serving BS 12 has received its request for handover. Then, the MS 10 sends an indication message MOB_HO-IND 106 with HO_IND_type 0b00 to release the Serving BS 12 at the moment while the MS 10 switches to another BS. In current WiMAX Specification, an acknowledgment of this release message 106 does not specifically define. Therefore, the Serving BS 12 will not send any message to the MS 10 to confirm the receiving of the release message 106, but will stop downlink and uplink scheduling for the MS 10 and will not respond to the bandwidth request from the MS 10 after receiving the release message 106.

The MS 10 may want to cancel the handover with the Serving BS 12 even if the handover process has begun. In this situation, the MS 10 can send an indication message MOB_HO-IND 108 with HO_IND_type 0b01 to the Serving BS 12 to cancel the handover process. However, if this indication message 108 is lost during transmission, an issue will occur. Since the Serving BS 12 does not receive the indication message 108 sent from the MS 10, downlink and uplink scheduling are still paused by Serving BS 12 and Serving BS 12 will not respond to the bandwidth request from the MS 10, while the MS 10 thinks that the handover is canceled and may request bandwidth or wait for unsolicited grant form the Serving BS 12. The states of the MS 10 and the Serving BS 12 are no longer synchronized.

FIG. 2 to FIG. 5 show other situations where the handover indication message 108 is lost during transmission. In FIG. 2, the MS 10 sends a MOB_HO-IND message 108 with HO_IND_type 0b01 to cancel the handover after sending the request message MOB_MSHO-REQ 102 but before receiving the response message MOB_BSHO-RSP 104. In FIG. 3, the indication message MOB_HO-IND 108 is sent after the response message MOB_BSHO-RSP 104 is received. In FIG. 4 and FIG. 5, the handover request message MOB_BSHO-REQ 110 is sent by the Serving BS 12 instead of the MS 10. After receiving the handover request message 110, the MS 10 should reply with an indication message 108, such as an indication message for canceling the handover, an indication message for rejecting the request, or an indication message for releasing the Serving BS 12, to indicate a decision of the MS 10. In FIG. 4 and FIG. 5, when the indication message 108 is lost, the MS 10 considers that the handover is canceled but the Serving BS 12 will still wait for the indication message MOB_HO-IND 108 from the MS 10 and may stop downlink and uplink scheduling. Confusion at both the MS 10 side and the Serving BS 12 side ensues.

FIG. 6 shows another situation where the handover request message MOB_BSHO-REQ 110 sent by the Serving BS 12 is lost. After sending the request message MOB_BSHO-REQ 110 with HO operation mode=0 or 1, the Serving BS 12 expects an indication message MOB_HO-IND from the MS 10. If the request message 110 is lost so the MS 10 is not aware of the handover request, the MS 10 will not send the indication message and the Serving BS 12 may stop the downlink and uplink scheduling. Moreover, if the Serving BS 12 does not allocate the unsolicited grant for the indication message, the Serving BS 12 may not be aware of the loss of the request message. In other words, the Serving BS 12 needs to spend extra effort on allocating UL grant for MOB-HO-IND message while BS thinks that the MS is going to perform HO, but MS does not even receive request message MOB_BSHO-REQ 110. Thus, the extra effort and time will degrade the system performance.

It is therefore a serious problem if the indication message or the handover request message is lost. An improved handover controlling process capable of detecting the lost is required.

### SUMMARY OF THE INVENTION

One objective of the present invention is to provide a handover handshake process capable of detecting the loss of handover messages such as the handover request message and the indication message. When the loss is detected, the MS or Serving BS can resend the lost message or perform some repairing steps to avoid the asynchronous states of the MS and the Serving BS. The problems met in the prior arts can therefore be solved.

According to one exemplary embodiment of the present invention, a handover controlling method implemented in a mobile station is disclosed. The method comprises sending or receiving a handover request message, and when an indication message for indicating a desired state of the handover is sent, detecting whether the indication message is lost, wherein the indication message does not include the handover request message.

According to another exemplary embodiment of the present invention, a handover controlling method implemented in a base station is disclosed. The method comprises sending a handover request message, and, when the handover request message is sent, detecting whether the handover request message is lost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 5 show diagrams of a conventional handover handshake process between an MS and a Serving BS, wherein a handover indication message is lost.

FIG. 6 shows a diagram of a conventional handover handshake process between an MS and a Serving BS, wherein a handover request message sent by the Serving BS is lost.

FIG. 7 shows a diagram of a handover handshake process between an MS and a Serving BS according to one exemplary embodiment of the present invention.

FIG. 8 shows a diagram of a handover handshake process between an MS and a Serving BS according to another exemplary embodiment of the present invention.

FIG. 9 shows a diagram of a handover handshake process between an MS and a Serving BS according to another exemplary embodiment of the present invention.

FIG. 10 shows a diagram of a handover handshake process between an MS and a Serving BS according to another exemplary embodiment of the present invention.

FIG. 11 shows a diagram of a handover handshake process between an MS and a Serving BS according to another exemplary embodiment of the present invention.

FIG. 12 shows a diagram of a handover handshake process between an MS and a Serving BS according to another exemplary embodiment of the present invention.

FIG. 13 shows a diagram of a handover handshake process between an MS and a Serving BS according to another exemplary embodiment of the present invention.

FIG. 14 shows a diagram of a handover handshake process between an MS and a Serving BS according to another exemplary embodiment of the present invention.

FIG. 15 shows a diagram of a handover handshake process between an MS and a Serving BS according to another exemplary embodiment of the present invention.

FIG. 16 shows a diagram of a handover handshake process between an MS and a Serving BS according to another exemplary embodiment of the present invention.

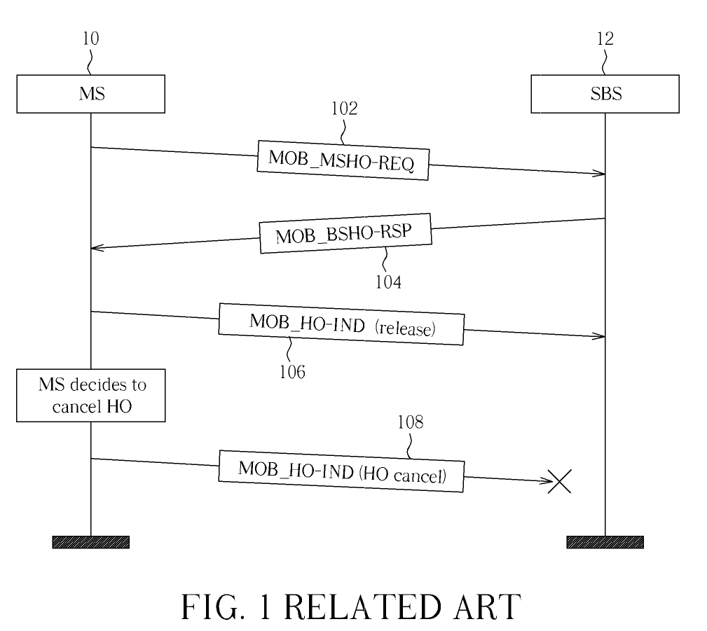

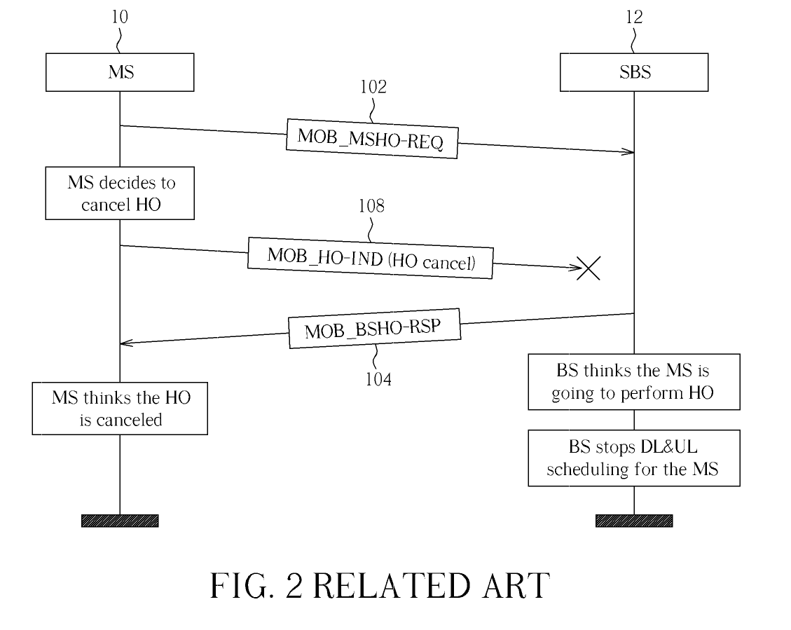

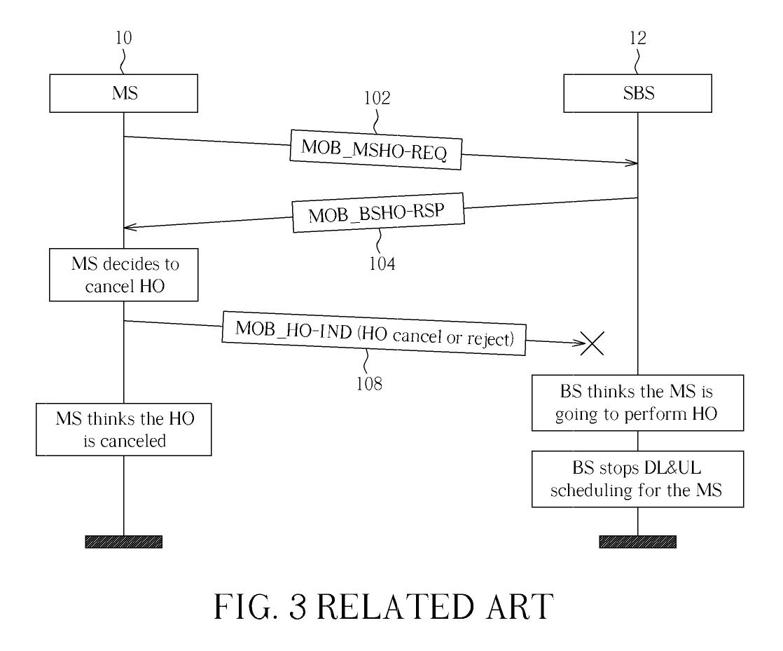

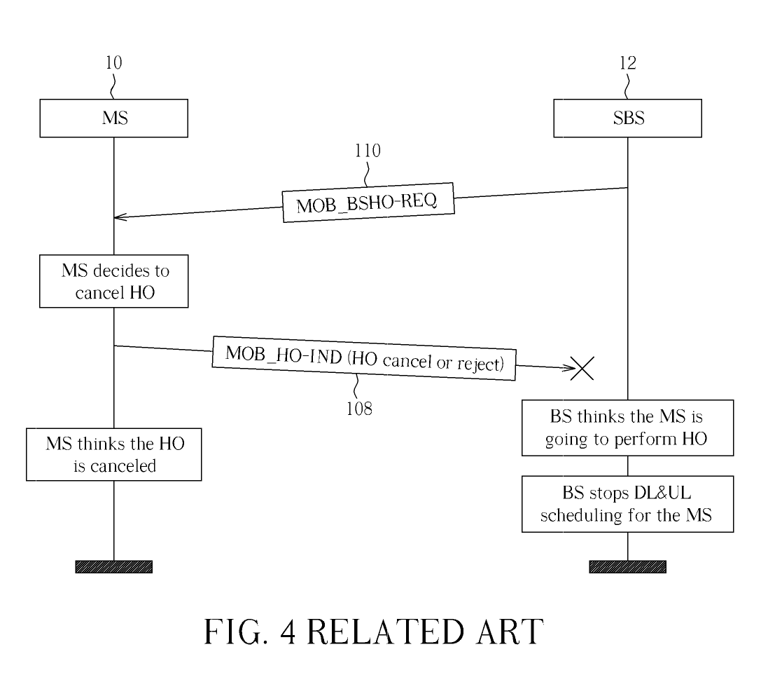

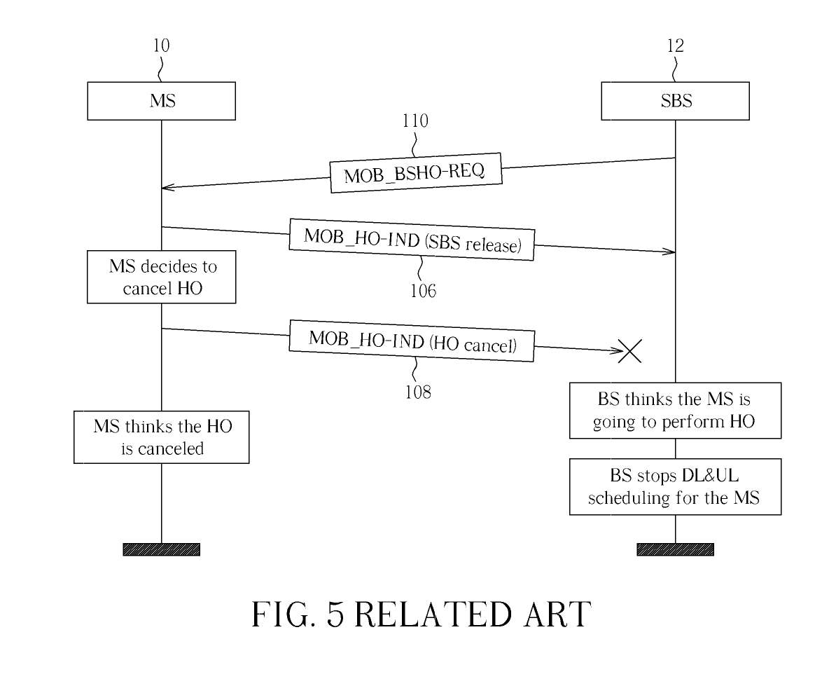

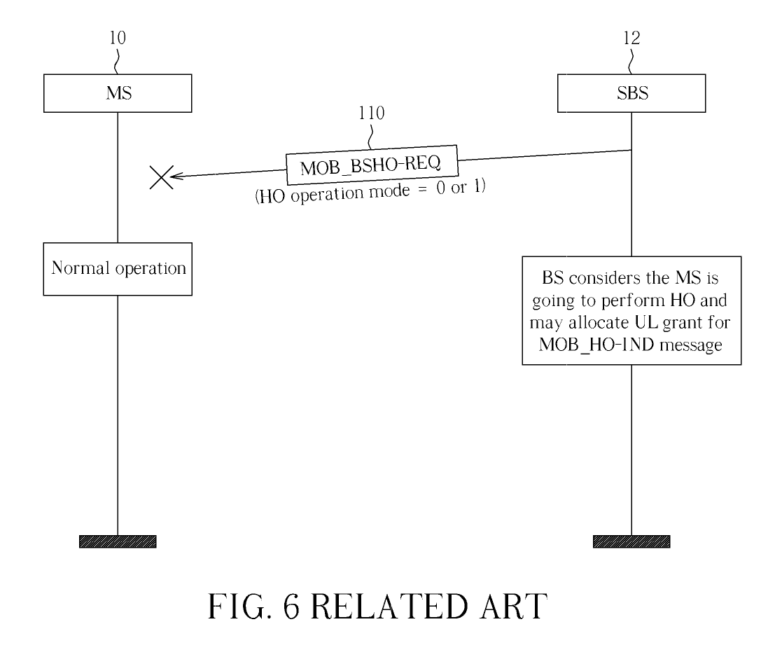

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

For the situation where a handover indication message (such as the cancel message with HO_IND_type 0b01) is lost, because the Serving BS has already stopped scheduling for the MS that is considered to perform handover to a Target BS (TBS), an issue arises when the Serving BS receives a bandwidth request from the MS. If the Serving BS is configured to consider that the bandwidth request means the MS is going to cancel the handover and therefore re-enables the scheduling for the MS when receiving the bandwidth request, a security problem will be introduced since any MS may cancel the handover on behalf of that MS.

Two solutions are proposed by the present invention. The first solution is to modify the handover controlling process so that the MS is able to detect whether an indication message is lost after it sends the indication message. The second solution is to modify handover controlling process such that the MS is able to perform a more robust handover process and avoid situations that indication message may be lost within a system with high probability of signal loss or there is no acknowledge to the indication message. In one embodiment, the MS starts a timer when it sends the indication message, and determines whether an acknowledgment is received before the timer expires. According to the determining result, the MS can determine whether the indication message is lost; the acknowledgment represents that the Serving BS has successfully received the indication message, and therefore the MS determines that the indication message is not lost if the acknowledgment is received before the timer expires.

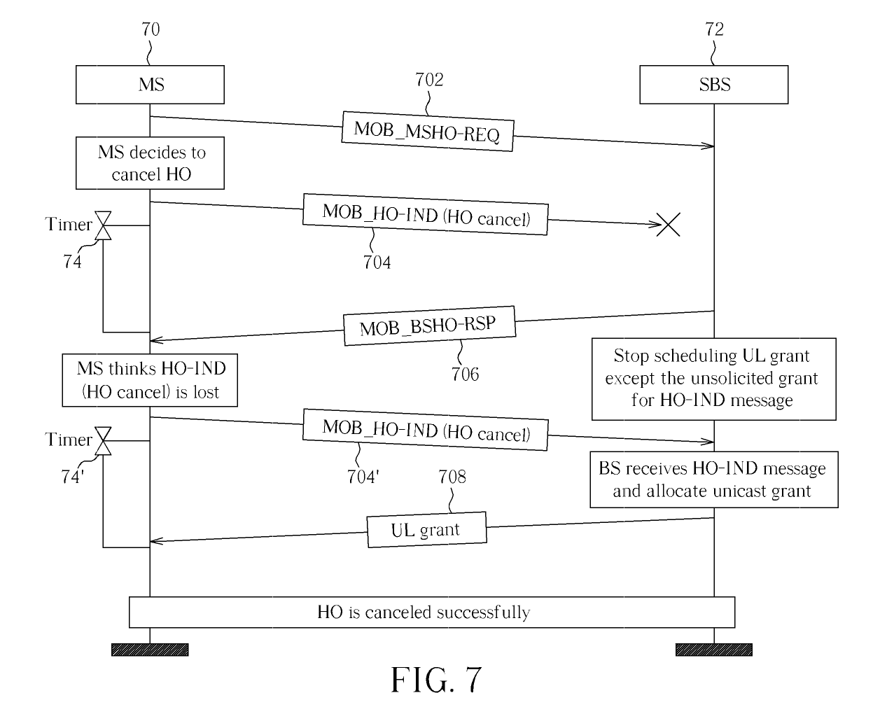

Please refer to FIG. 7, which is a diagram showing a handover handshake process between an MS 70 and a Serving BS 72 according to one exemplary embodiment of the present invention. After the MS 70 sends a handover request message MOB_MSHO-REQ 702, it decides to cancel the handover and sends a cancel message MOB_HO-IND 704 with HO_IND_type 0b01 to the Serving BS 72. In the meantime, a timer 74 in the MS 70 is started to count a predetermined time period. The predetermined time period may correspond to the urgency of the handover indication message 704 (in this embodiment, the urgency of canceling the handover) or correspond to the required time period for the Serving BS 72 to process the received handover indication message 704 and give an acknowledgement back to the MS 70.

In this embodiment, the indication message MOB_HO-IND 704 sent from the MS 70 is lost during transmission. In order to make the MS 70 able to detect the loss, the actions that the Serving BS 72 performs after receiving the handover request are modified to be different from the prior art: the Serving BS 72 not only responds to the handover request by sending a MOB_BSHO-RSP message 706, but also stops allocating uplink allocations to the MS 70 except for an unsolicited grant or contention bandwidth request for transmitting a handover indication message MOB_HO-IND 704. Moreover, the behaviors of the Serving BS 72 when receiving the handover indication message 704 are also different from the prior art correspondingly: the Serving BS 72 should allocate a unicast grant to the MS 70 as an acknowledgement of reception of the indication message 704 that the HO_IND_type indicates to cancel or reject the handover, and should resume the uplink scheduling for the MS 70 upon receiving one of the following messages: MOB_HO-IND message to cancel or reject the handover, and the MOB_MSHO-REQ message.

Since the indication message 704 is lost, the Serving BS 72 will not allocate the unicast grant to the MS 70 as the acknowledgement. As a result, the MS 70 will not receive any unicast grant before the expiration of the timer 74, and it therefore determines that the indication message 704 is lost. The MS 70 can retransmit the indication message, send a new handover request message to handover to the Target BS, or initiate a network entry process with the Serving BS 72. In this embodiment, as shown in FIG. 7, the MS 70 resends the indication message 704′ to the Serving BS 72 to cancel the handover, and starts a timer 74′ when sending the handover indication message 704′. The Serving BS 72 successfully receives the message 704′ this time, and then allocates a unicast grant 708 to the MS 70 as an acknowledgement. As shown in FIG. 7, the MS 70 receives the acknowledgement 708 from the Serving BS 72 before the timer 74′ expires; the MS 70 therefore knows that the Serving BS 72 has been notified of the cancellation. The handover process can therefore be canceled successfully even if the cancel message is lost once.

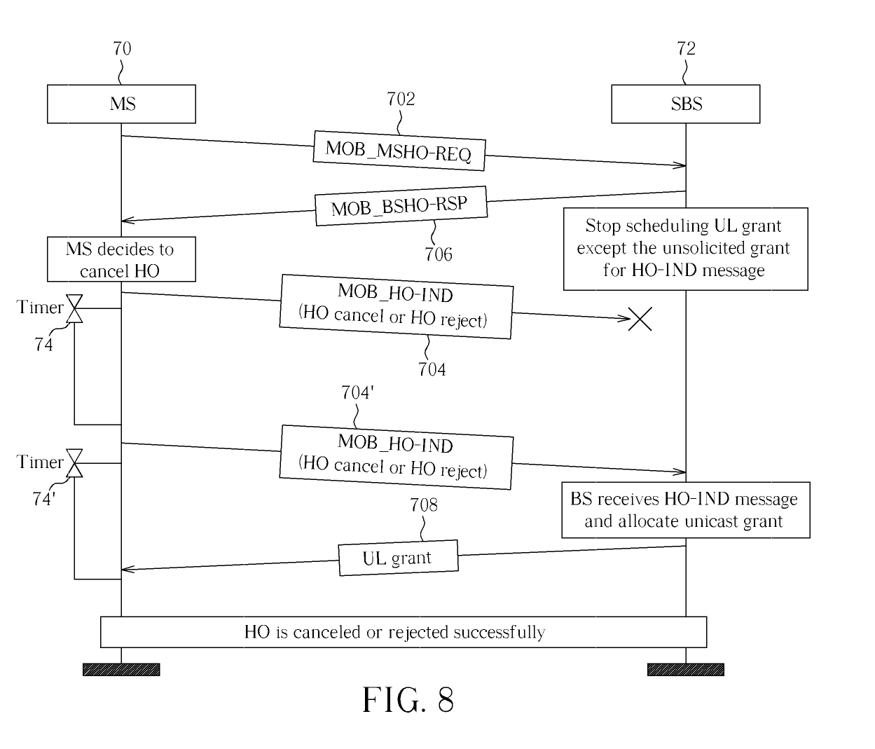

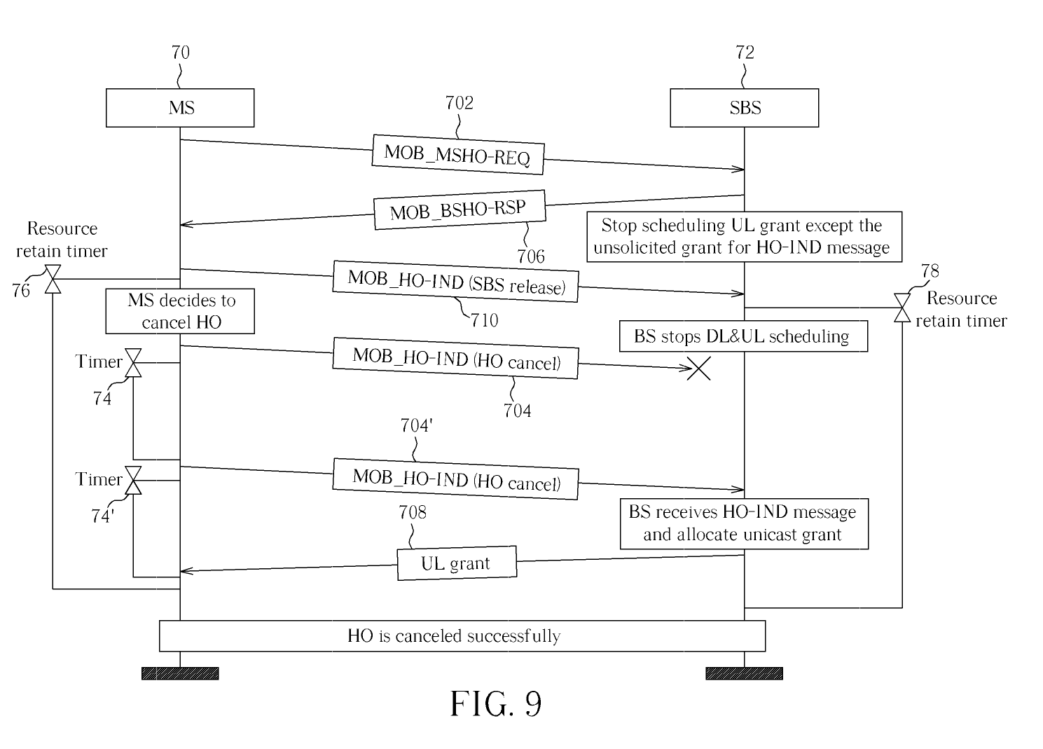

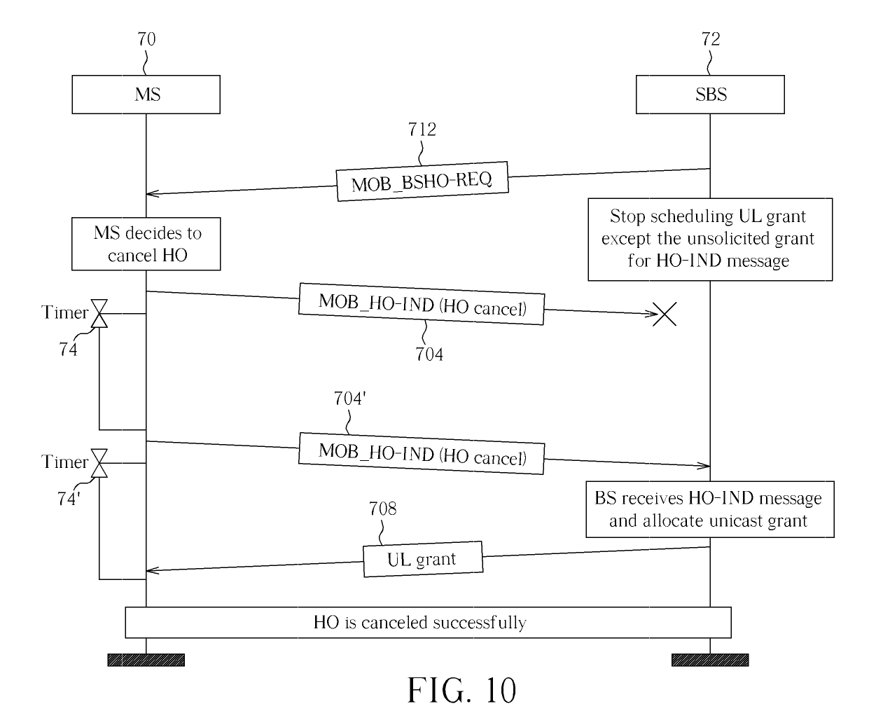

In the handover handshake processes of FIG. 8, FIG. 9 and FIG. 10, the MS 70 decides to cancel or reject the handover after a handover process is started, and sends an indication message 704 to the Serving BS 72. Similar to the embodiment shown in FIG. 7, by setting a timer 74(74′) and setting a unicast grant 708 as an acknowledgement, the MS 70 can detect the loss of the indication message 704 and resend it, so the handover is thereby canceled or rejected successfully. Moreover, resource retain timers 76 and 78 is introduced in FIG. 9. As is well known to those having ordinary skill in the art, the resource retain timer 76(78) is set when the handover is performed to retain resources for the MS 70 during a resource retain time. In other words, before the resource retain timer 76(78) expires, the Serving BS 72 retains the connections, media access control (MAC) state machines and protocol data units (PDUs) associated with the MS 70. The resource can be utilized for the MS 70 to resume the connection to the Serving BS 72 even if the handover fails. However, after the expiration of the resource retain timer 76(78), the MS 70 does not listen to the Serving BS 72 downlink traffic anymore and the Serving BS 72 will terminate the connections with the MS 70. Therefore the handover indication message MOB_HO-IND 704(704′) must be sent prior to the expiration of the resource retain timer 76(78), and the predetermined time period of the timer 74(74′) needs to be shorter than the resource retain time of the resource retain timer 76(78).

In another embodiment, an existing message or a combination of existing messages is chosen to be the acknowledgement of the reception of the indication message 704. Each of the existing messages may represent a predetermined action in a specific process different from the handover process, but represent no meaning or no action in a conventional handover process. For example, the Serving BS 72 may send a ranging response message RNG-RSP containing no physical layer adjustment to the MS 70 as an acknowledgement. Since the ranging response message RNG-RSP is utilized to contain initial information in an initial network ranging process, and contain physical layer adjustments such as time adjustment and power adjustment in a normal operation from the Serving BS 72 to the MS 70, a ranging response message RNG-RSP with success status and without any physical layer adjustment is not a regular message in the normal operation and is only utilized to respond to the indication message in the modified handover process. In other words, when the MS 70 receives a ranging response message RNG-RSP containing no physical layer adjustment, it realizes that this message must be sent from the Serving BS 72 as the acknowledgement of the reception of the indication message. The advantage of this embodiment is that the Serving BS 72 does not need to stop scheduling for the MS 70 when the handover is requested, providing more flexibility to the implementation of the handover process.

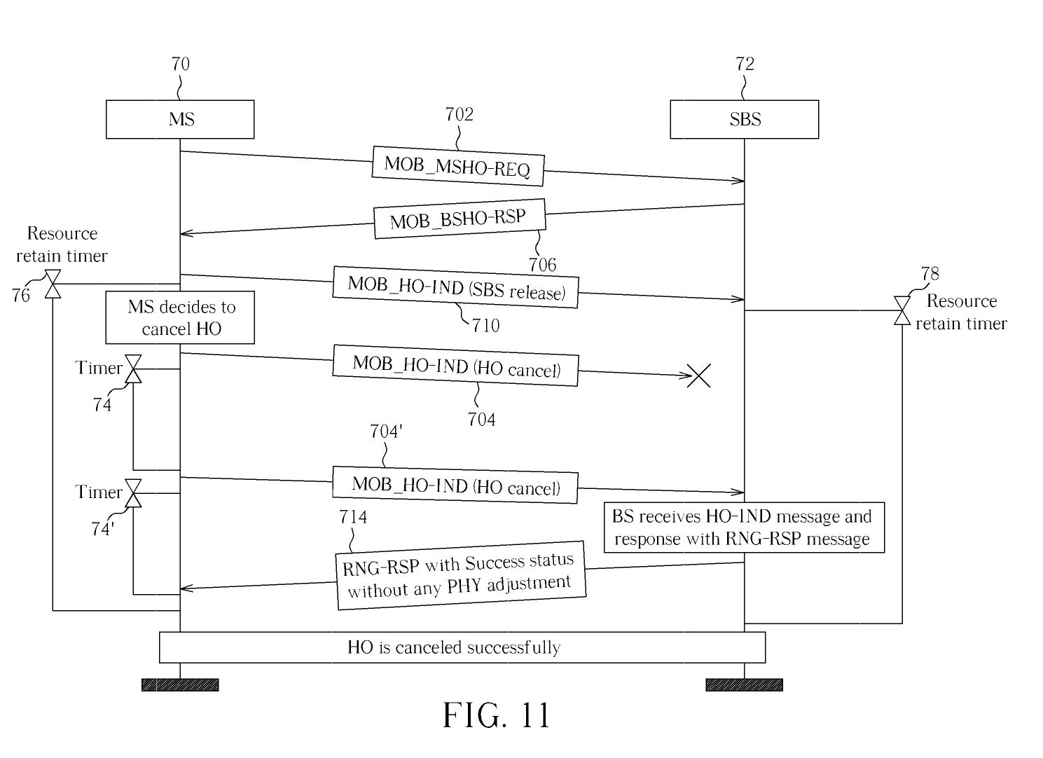

Please refer to FIG. 11, which shows a diagram of a handover handshake process based on the above acknowledgement scenario according to one exemplary embodiment of the present invention. In FIG. 11, the MS 70 starts a timer 74 when it sends the MOB_HO-IND message 704 with HO_IND_type 0b01 to cancel the handover. If the MS 70 does not receive a RNG-RSP message with success status but containing no physical layer adjustment before the expiration of the timer 74, it determines that the MOB_HO-IND message 704 is lost and should either retransmit the MOB_HO-IND message, perform a handover with the Target BS by sending a new handover request message, or initiate a network entry process with the Serving BS 72. In this embodiment, the MS 70 resends the MOB_HO-IND message 704, and the message 704′ is received by the Serving BS 72. When the Serving BS 72 receives the MOB_HO-IND message 704′ from the MS 70, it sends an RNG-RSP message 714 over Basic CID of the MS with Success status and without any PHY adjustment as an acknowledgement. As the MS 70 receives this acknowledgement, the states of the MS 70 and the Serving BS 72 are settled; the handover is canceled successfully, and the problem resulting from the lost of the MOB_HO-IND message 704 is avoided.

The above-mentioned timer 74(74′) also operates under the resource retain timer 76(78). That is, the mechanism should be utilized before the resource retain timer 76(78) expires. If the Serving BS 72 receives the bandwidth request from the MS 70 when the resource is not retained anymore, it should ignore the bandwidth request or send an RNG-RSP message over Basic CID with Abort status to the MS 70. The MS 70 should perform a handover to other BS or perform an initial network entry with the Serving BS 72 when receiving the RNG-RSP message over Basic CID with Abort status.

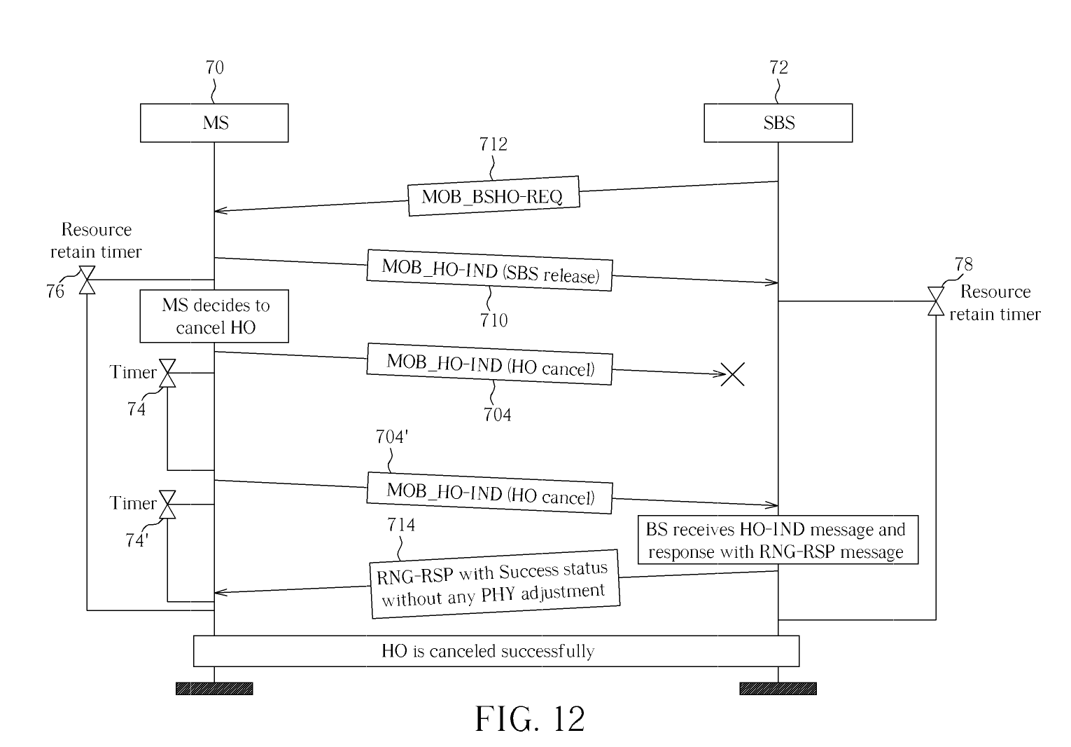

FIG. 12 shows another embodiment where the timer 74(74′) and the acknowledgement message benefit the MS 70 to detect the loss of the MOB_HO-IND message 704. In this embodiment, the handover request 712 originates from the Serving BS 72, and the MS 70 decides to cancel the handover after it has sent an indication message 710 to release the Serving BS 72. As can be seen, the mechanism helps the MS 70 to detect the loss of the indication message 704 and cancel the handover successfully.

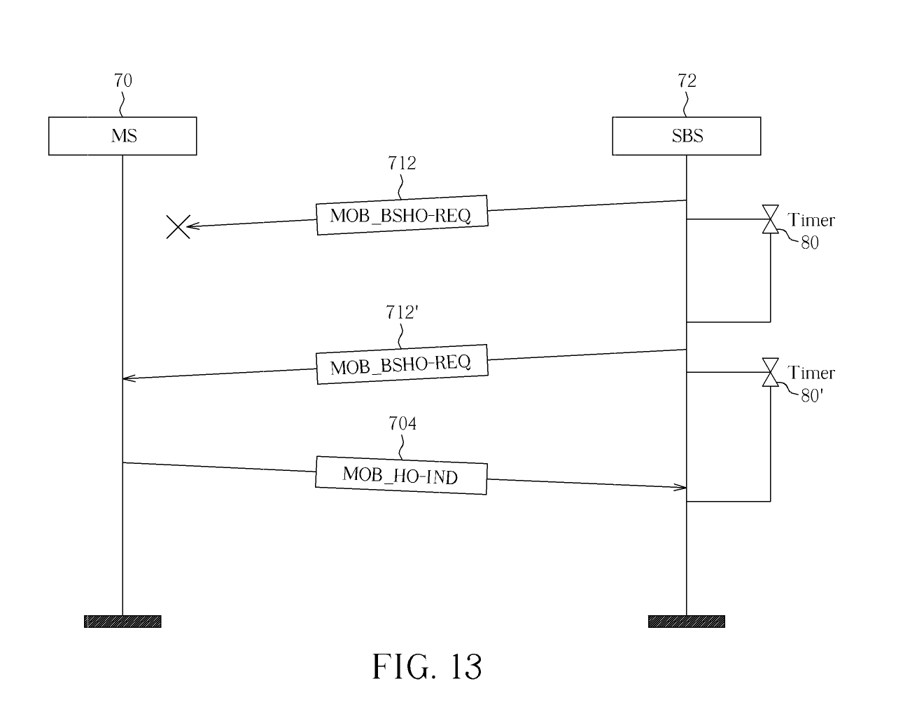

Similarly, to solve the problem caused by the loss of the MOB_BSHO-REQ message, the Serving BS 72 could detect whether the MOB_BSHO-REQ message is lost by setting a timer and an acknowledgement. As shown in FIG. 13, when the Serving BS 72 sends the MOB_BSHO-REQ message 712, a timer 80 is started. The Serving BS 72 determines whether an acknowledgment message indicative of a receipt of the MOB_BSHO-REQ message 712 is received before the timer 80 expires, and determines whether the MOB_BSHO-REQ message 712 is lost according to the determining result. The indication message MOB_HO-IND 704 now concurrently serves as an indication bringing MS's desired state (e.g. cancellation or rejection) of handover and an acknowledgement message indicative of a receipt of the handover request message MOB_BSHO-REQ 712. If a handover indication message MOB_HO-IND 704 is not received before the timer 80 expires, the Serving BS determines that the MOB_BSHO-REQ message 712 is lost, and it should retransmit the MOB_BSHO-REQ message.

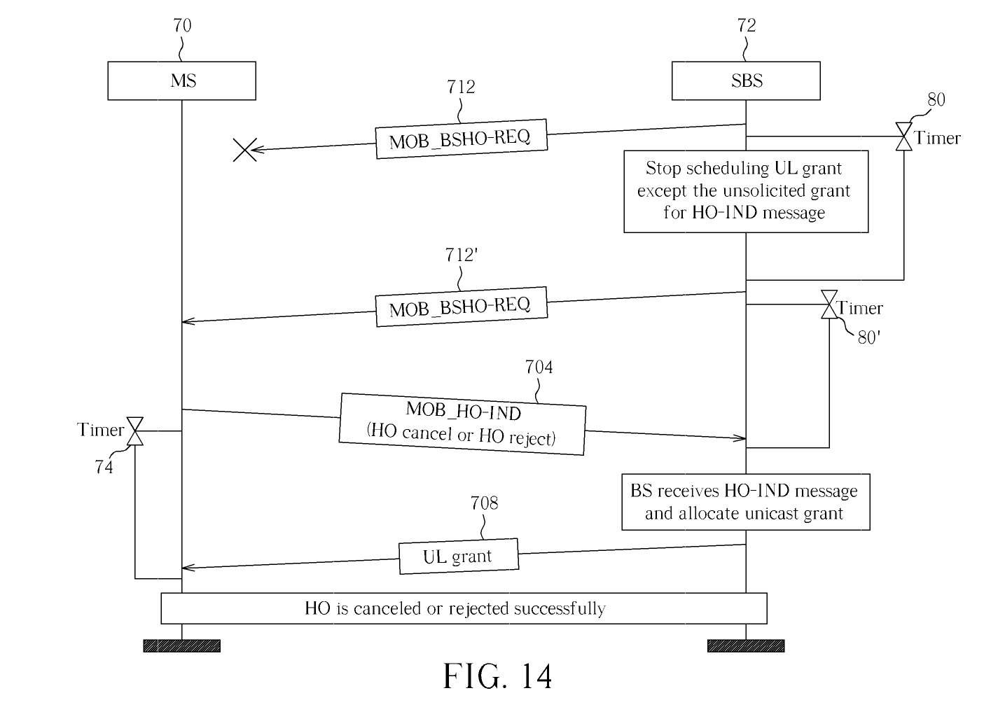

FIG. 14 shows an embodiment combining the mechanisms shown in FIG. 10 and FIG. 13. When the Serving BS 72 sends the MOB_BSHO-REQ message 712, a timer 80 is started and the uplink grant scheduling is stopped except for the unsolicited grant for transmission of the indication message MOB_HO-IND 704. If a handover indication message MOB_HO-IND 704 is not received before the timer 80 expires, the Serving BS 72 determines that the MOB_BSHO-REQ message 712 is lost, and it should retransmit the MOB_BSHO-REQ message or stop downlink/uplink allocations. In this embodiment, the Serving BS 72 resends the MOB_BSHO-REQ message 712′ and starts a timer 80′ again. If an indication message MOB_HO-IND 704 is received before the timer 80′ expires, the Serving BS 72 acts according to the received indication message MOB_HO-IND 704; for example, the Serving BS 72 allocates a unicast grant 708 as an acknowledgment of the indication message 704 that cancels the handover.

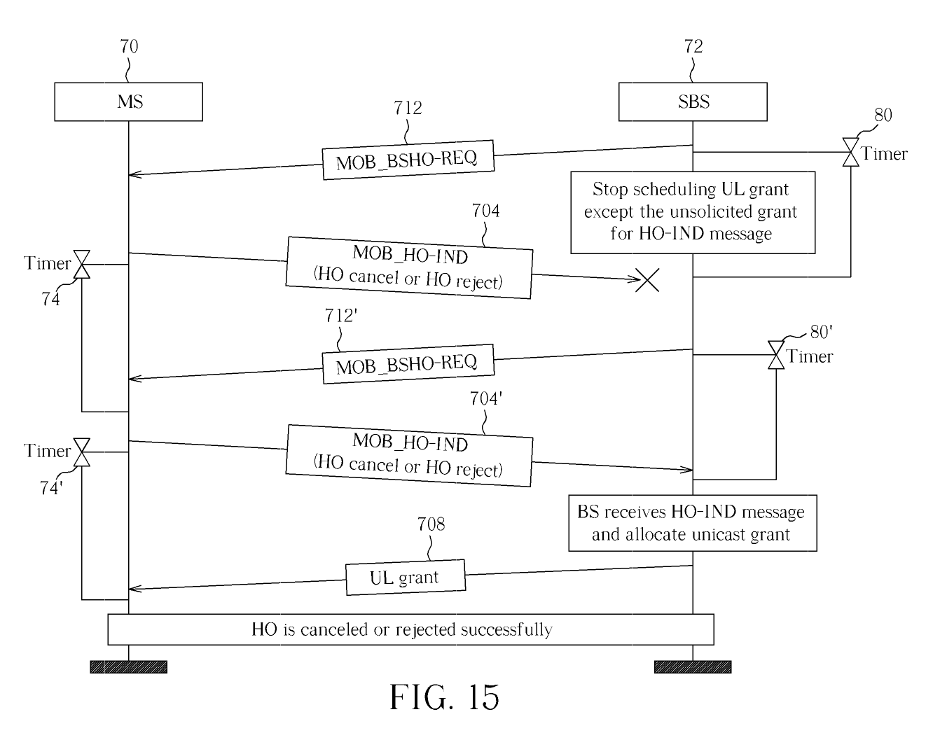

FIG. 15 shows another example. In FIG. 15, the indication message 704 of the MS 70 in response to the handover request message 712 is lost during transmission, and the Serving BS 72 therefore does not receive any acknowledgement message from the MS 70 before its timer 80 expires. A handover request message MOB_BSHO-IND 712′ is sent again and a timer 80′ is started by the Serving BS 72. Since the MS 70 does not receive an acknowledgement from the Serving BS 72 (note that the acknowledgement of the indication message 704 is chosen to be the unicast grant in this embodiment), it resends the indication message 704′ and starts a timer 74′. When the indication message 704′ is successfully received by the Serving BS 72, it allocates the unicast grant 708 in return. When the MS 70 receives this grant 708 before its timer 74′ expires, the handover is cancelled (or rejected) successfully.

The mechanism provided in the above embodiments benefits the MS 70 to detect the loss of the indication message 704 and the Serving BS 72 to detect the loss of the handover request message 712. Note that although a indication message for canceling the handover is taken as an example frequently in the above description, the present invention is not limited to the MS 70 detecting the loss of this indication message; it can be extended to the MS 70 detecting other indication messages (however, the handover request message MOB_MSHO-REQ 702 that is sent by the MS 70 is not included).

When the loss is detected, the MS 70 or Serving BS 72 can resend the lost message or perform some repairing steps to avoid the asynchronous states of the MS 70 and the Serving BS 72. The problems met in the prior arts can therefore be solved. The present invention clarifies the expected behavior of the MS 70 and Serving BS 72 in the situation where the above-mentioned messages are lost.

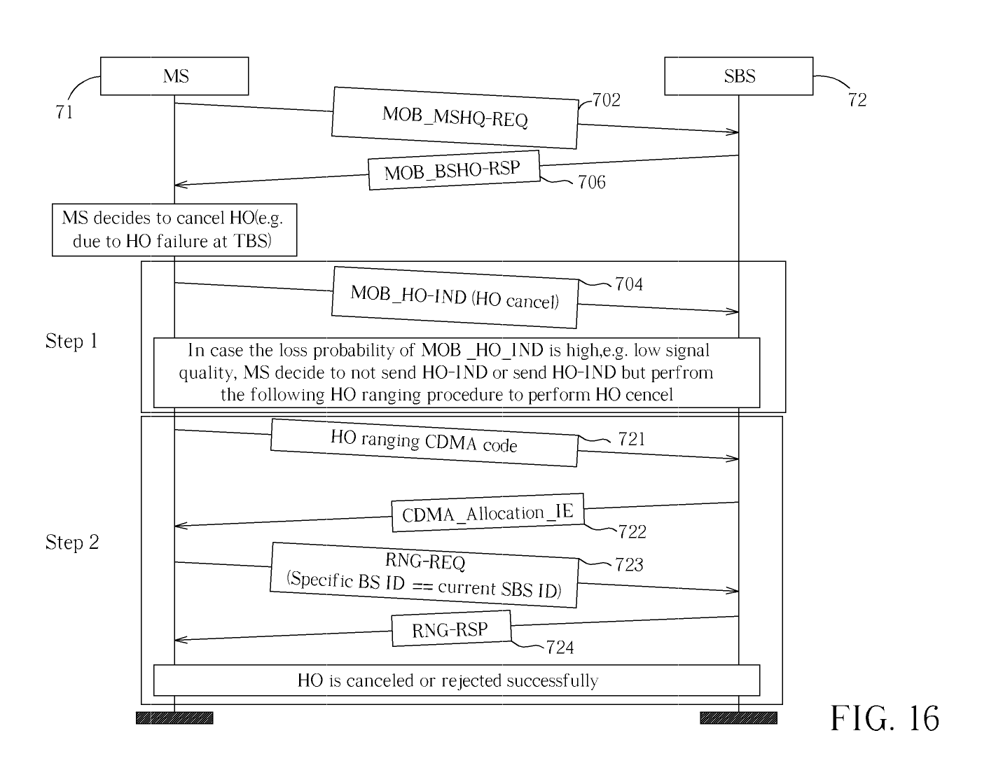

In FIG. 16, it's another embodiment of the present invention for handover controlling process. MS 71 is able to decide whether to skip a process, e.g., step 1 (sending indication message MOB_HO-IND 704 to cancel handover) and perform more robust handover procedures as step 2 to cancel the handover procedure. In the case that the loss rate of indication message is high, MS 71 may decide whether to send the indication message or not. For some exemplary embodiment, the indication message may be decided not to send, and the robust handover procedure is directly performed as step 2. The loss rate of message can be detected via various factors, such as no acknowledgement of the reception of the indication message MOB_HO-IND 704, acknowledgement of the reception of the indication message MOB_HO-IND 704 is not implemented by the serving BS 72 (learning from the capability negotiation), noise signal, interference level, or signal quality. In the cases that there is no acknowledgement of the reception of the indication message, the acknowledgement of the reception of the indication message is not implemented by the serving BS, noise level or interference level is high, or signal quality is low, the loss rate is identified to be high. In FIG. 16, the step 2 starts handover ranging CDMA code for parameters adjustment. Please note that the handover ranging CDMA code is a general code for communicating with BS, and there may be other handover ranging code format for the parameter adjusting purpose. The parameters may be power, frequency offset, and other relevant information of negotiation between MS 71 and serving BS 71. The serving BS 72 responds with message CDMA_Allocation_IE 722, CDMA allocation information-element, as an uplink grant with bandwidth allocation information. The MS 71 sends a message (i.e., a ranging request) RNG-REQ 723 to define the status. The serving BS 72 sends back a ranging response RNG-RSP 724. The ranging request RNG-REQ 723 comprises at least two IDs, one is MS ID for indicating the MS 71 and the other is a specific BS ID. If the specific BS ID is chosen to be the current serving BS 72 ID by MS 71, the serving BS 72 will know the handover process is cancelled and return a response. If the specific BS ID is not the current serving BS 72 ID, the serving BS 72 will know that the handover process is not cancelled and return a response. When serving BS 72 receives MS ID included in the serving list of the serving BS 72, which comprises the MS data context and data connection with MS 71, and the specific BS ID is a current serving BS ID. The serving BS will know that the handover process is intended to be cancelled by MS 71. Please note that in the normal handover procedure, the MS ID is not founded in serving BS 72 and the specific BS ID is different from the current BS ID.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A handover controlling method implemented in a mobile station, comprising:
sending or receiving a handover request message that requests a handover; and
when an indication message for indicating a desired state of the handover is sent, detecting whether the indication message is lost, wherein the indication message does not include the handover request message.

2. The handover controlling method of claim 1, wherein the indication message comprises a handover cancel message.

3. The handover controlling method of claim 1, wherein the step of detecting whether the indication message is lost comprises:
starting a timer when the mobile station sends the indication message;
determining whether an acknowledgment is received before the timer expires to generate a determining result; and
determining whether the indication message is lost according to the determining result.

4. The handover controlling method of claim 3, wherein the acknowledgment corresponds to an existing message or a combination of existing messages, where each existing message represents a predetermined action in a specific process different from a handover process.

5. The handover controlling method of claim 4, wherein the acknowledgment is a ranging response message containing no physical layer adjustment.

6. The handover controlling method of claim 3, wherein the acknowledgment is for allocating a unicast grant.

7. The handover controlling method of claim 1, further comprising:
when a detecting result indicates that the indication message is lost, resending the indication message.

8. The handover controlling method of claim 1, further comprising:
when a detecting result indicates that the indication message is lost, sending a new handover request message.

9. The handover controlling method of claim 1, further comprising:
when a detecting result indicates that the indication message is lost, initiating a network entry process.

10. A handover controlling method implemented in a base station, comprising:
sending a handover request message that requests a handover; and
when the handover request message is sent, detecting whether the handover request message is lost.

11. The handover controlling method of claim 10, wherein the step of detecting whether the handover request message is lost comprises:
starting a timer when the base station sends the handover request message;
determining whether an acknowledgment message indicative of a receipt of the handover request message is received before the timer expires to generate a determining result; and
determining whether the handover request message is lost according to the determining result.

12. The handover controlling method of claim 11, wherein the acknowledgment message comprises a handover indication message.

13. The handover controlling method of claim 10, further comprising:
when a detecting result indicates that the handover request message is lost, resending the handover request message.

14. The handover controlling method of claim 10, further comprising:
when a detecting result indicates that the handover request message is lost, stopping a downlink/uplink allocation process.

15. The handover controlling method of claim 10, further comprising:
sending an acknowledgment when receiving an indication message indicating a desired state of the handover from a mobile station.

16. The handover controlling method of claim 15, wherein the indication message comprises a handover cancel message.

17. The handover controlling method of claim 15, wherein the acknowledgment corresponds to an existing message or a combination of existing messages, where each existing message represents a predetermined action in a specific process different from a handover process.

18. The handover controlling method of claim 17, wherein the acknowledgment is a ranging response message containing no physical layer adjustment.

19. The handover controlling method of claim 15, further comprising: stopping allocating a unicast grant to the mobile station after sending the handover request message;
wherein the acknowledgment sent to the mobile station when the base station receives the indication message is for allocating a unicast grant.

20. A handover controlling method implemented in a mobile station, comprising:
sending a handover ranging code for acquiring parameter adjustment information;
receiving an uplink grant message from a current serving base station with a bandwidth allocation information;
sending a ranging request, wherein the ranging request comprises at least two identities (IDs); and,
receiving a ranging response to indicate whether a handover process is cancelled.

21. The handover controlling method of claim 20, further comprising:
sending an indication message for indicating a predetermined state of the handover process.

22. The handover controlling method of claim 21, wherein the indication message comprises a handover cancel message.

23. The handover controlling method of claim 20, further comprising:
detecting whether to send the indication message according to a signal quality of signals from the current serving base station.

24. The handover controlling method of claim 23, further comprising:
detecting whether to send the indication message according to a negotiated capability of the current serving base station.

25. The handover controlling method of claim 20, wherein the ranging request comprises a mobile station ID and a specific ID, and the specific ID is chosen to be the same as a current serving base station ID if the mobile station intends to cancel the handover process.
